(19) United States
(12) Patent Application Publication
(10) Pub. No.: US 2025/0292381 A1
(43) Pub. Date: Sep. 18, 2025

(54) ANALYSIS METHOD AND RELATED SYSTEM FOR IMAGE DATA UNDER PRESSURE

(71) Applicants: Inventec (Pudong) Technology Corp., Shanghai (CN); Inventec Corporation, Taipei (TW)

(72) Inventors: Tzu-Chi Chien, Taipei (TW); Yi-Feng Fan, Taipei (TW)

(73) Assignees: Inventec (Pudong) Technology Corp., Shanghai (CN); Inventec Corporation, Taipei (TW)

(21) Appl. No.: 18/655,319

(22) Filed: May 5, 2024

(30) Foreign Application Priority Data
Mar. 14, 2024 (CN) 202410294835.6

(51) Int. Cl. G06T 7/00

(52) U.S. Cl. CPC G06T 7/0002; G06T 2207/10024; G06T 2207/20072

(57) ABSTRACT

An analysis method for an image data under pressure, includes inputting an image; transforming the image into a grayscale image; clustering each pixel of the grayscale image to obtain a plurality of image data groups; determining a pressure state of the image according to the plurality of image data groups; and determining an area under pressure of the image according to the pressure state of the image.

### BACKGROUND OF THE INVENTION

### 1. Field of the Invention

The present invention relates to an analysis method and related system for an image data under pressure, and more particularly, to an analysis method and related system for an image data under pressure, capable of clustering image pixels of image data with machine learning models.

### 2. Description of the Prior Art

When analyzing data of conventional computer aided engineering (CAE), the area under pressure of image data is necessarily determined. Since the area under pressure of the image data cannot be determined in advance, the analysis for the area under pressure can be performed only after positions corresponding to the image are determined, which increases the complexity of analysis, and overly consumes calculation resources of servers.

In addition, the conventional computer aided engineering (CAE) software, e.g., Abaqus, Ansys, performs mechanics analysis for non-linear Finite elements. However, Abaqus only provides output options of total area under pressure and cannot output details corresponding to different areas under pressure. The details corresponding to different areas under pressure can only be determined by manual estimation, which cannot guarantee the precision of the analysis data.

Therefore, improvements are necessary to the conventional techniques.

### SUMMARY OF THE INVENTION

Therefore, the present invention provides an analysis method and related system for an image data under pressure to quantify the image data for analysis.

An embodiment of the present invention discloses an analysis method for an image data under pressure, comprises inputting an image; transforming the image into a grayscale image; clustering each pixel of the grayscale image to obtain a plurality of image data groups; determining a pressure state of the image according to the plurality of image data groups; and determining an area under pressure of the image according to the pressure state of the image.

Another embodiment of the present invention discloses an analysis system for an image data under pressure, comprises a processing device; and a memory device, coupled to the processing device, configured to store a program code for instructing the processing device to execute an analysis method for an image data under pressure, wherein the analysis method comprises inputting an image; transforming the image into a grayscale image; clustering each pixel of the grayscale image to obtain a plurality of image data groups; determining a pressure state of the image according to the plurality of image data groups; and determining an area under pressure of the image according to the pressure state of the image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an analysis system for image data under pressure according to an embodiment of the present invention.

FIG. 2 is a schematic diagram of an analysis method for image data under pressure according to an embodiment of the present invention.

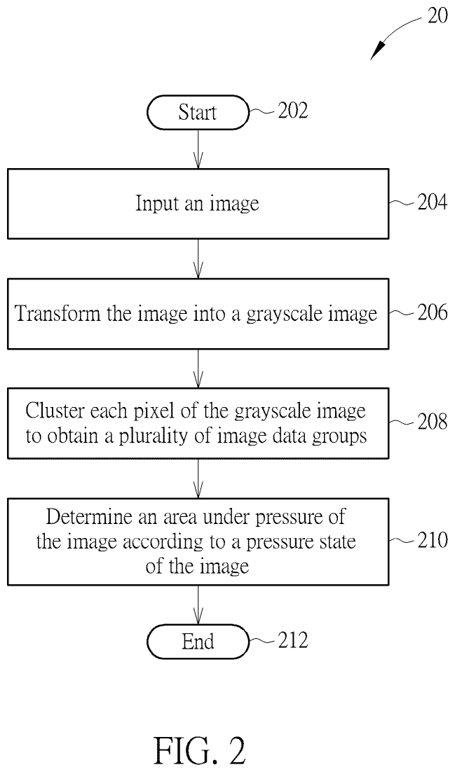

FIG. 3 is a schematic diagram of quantified stress areas of a microphone rubber according to an embodiment of the present invention.

FIG. 4 is a schematic diagram of clustering a grayscale image data according to an embodiment of the present invention.

FIG. 5 is a statistical diagram of quantities of RGB values of the grayscale image before clustering with a K-means algorithm according to an embodiment of the present invention.

FIG. 6 is a statistical diagram of quantities of RGB values of the grayscale image after clustering with the K-means algorithm according to an embodiment of the present invention.

### DETAILED DESCRIPTION

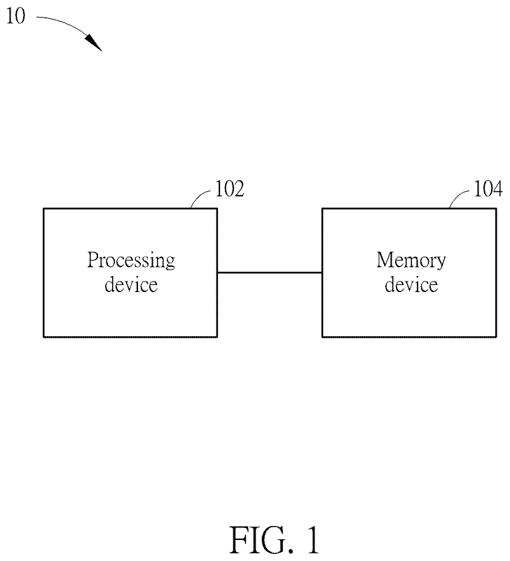

Please refer to FIG. 1, which is a schematic diagram of an analysis system 10 for image data under pressure according to an embodiment of the present invention. The analysis system 10 for image data under pressure includes a processing device 102 and a memory device 104. The memory device 104 is coupled to the processing device 102, and is configured to store a program code for instructing the processing device 102 to execute an analysis method 20 for an image data under pressure. The analysis method 20 for the image data under pressure may be utilized for recognizing areas under pressure in the image to obtain precise quantified data. The analysis method 20 for an image data under pressure includes the following steps:
Step 202: Start;
Step 204: Input an image;
Step 206: Transform the image into a grayscale image;
Step 208: Cluster each pixel of the grayscale image to obtain a plurality of image data groups;
Step 210: Determine an area under pressure of the image according to a pressure state of the image;
Step 212: End.

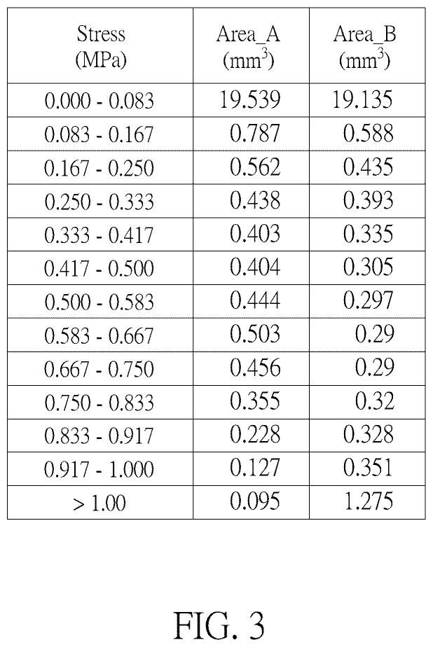

The analysis system 10 for image data under pressure according to an embodiment of the present invention may precisely recognize and extract areas under pressure from images based on the analysis method 20 to obtain precise quantified data. Take a microphone rubber for example, quantified data of areas Area_A and Area_B corresponding to different stresses may be obtained after an analysis of a machine learning model, as shown in FIG. 3.

As shown in FIG. 3, when a contact stress of the microphone rubber is over 1 MPa, the stressed area of the areas Area_A and Area_B are respectively 0.095 mm³ and 1.275 mm³. Therefore, a precision of the data analysis may be increased according to the precise quantified data to highlight an obvious difference of products in the airtightness.

In order to decrease a complexity of clustering algorithm, the analysis system 10 for image data under pressure according to an embodiment of the present invention transforms color images into grayscale images and then groups the grayscale values, i.e. RGB values, of each pixel of the grayscale images to improve calculation efficiency.

In step 204 and step 206, the analysis system 10 for image data under pressure inputs the image, and transforms the image into a grayscale image. In step 208, the analysis system 10 for image data under pressure performs the clustering for each pixel of the grayscale image to obtain the plurality of image data groups.

In an embodiment, a K-means algorithm for a scikit-learn of machine learning of Python program language is utilized, e.g., Lloyd and Elkan algorithms. In the example of Lloyd algorithm, in order to ensure that data points, i.e., pixels of the grayscale image, in the identical group of the image data groups share similar characteristics, and obvious differences of characteristic exists between each group, k sets of groups Sᵢ are determined in a data set (x₁, x₂, . . . , xₙ), such that a minimal value of a within-group sum of squares (WCSS) of the groups Sᵢ is achieved, as shown in formula (1).

$$arg min {\sum }_{i = 1}^{k} {\sum }_{x ∈ {S}_{i}} {‖ x - {μ}_{i} ‖}^{2} \qquad ( 1 )$$

wherein μᵢ is an average value of all points in Sᵢ.

First, a group center point of the image data groups is initialized with the k-means++ to ensure that distances between the center points of each group is far enough. In this way, the analysis system 10 for image data under pressure according to an embodiment of the present invention randomly chooses a first center point, calculates the distances between first center point and other pixels, and selects the center points of other image data groups with an iteration method, wherein the iteration method takes the distances as parameters with probability.

Then, each pixel (i.e., data point) of the image data groups is clustered into a group with a nearest distance to the center point of the group. Notably, the pixels of each image data group are allocated into a single group. In other words, one pixel (i.e., data point) cannot be grouped into multiple data groups.

After the above clustering steps, the analysis system 10 for image data under pressure according to an embodiment of the present invention recalculates the center point mᵢ of each data group with formula (2) to update the center points of all image data groups until the center point of the data groups stays unchanged or a predetermined maximal iteration amount is satisfied to finish the allocation of the image data groups.

$${m}_{i}^{( t + 1 )} = \frac{1}{{s}_{i}^{( t )}} {\sum }_{{x}_{j} ∈ {S}_{i}^{t}} {x}_{j} \qquad ( 2 )$$

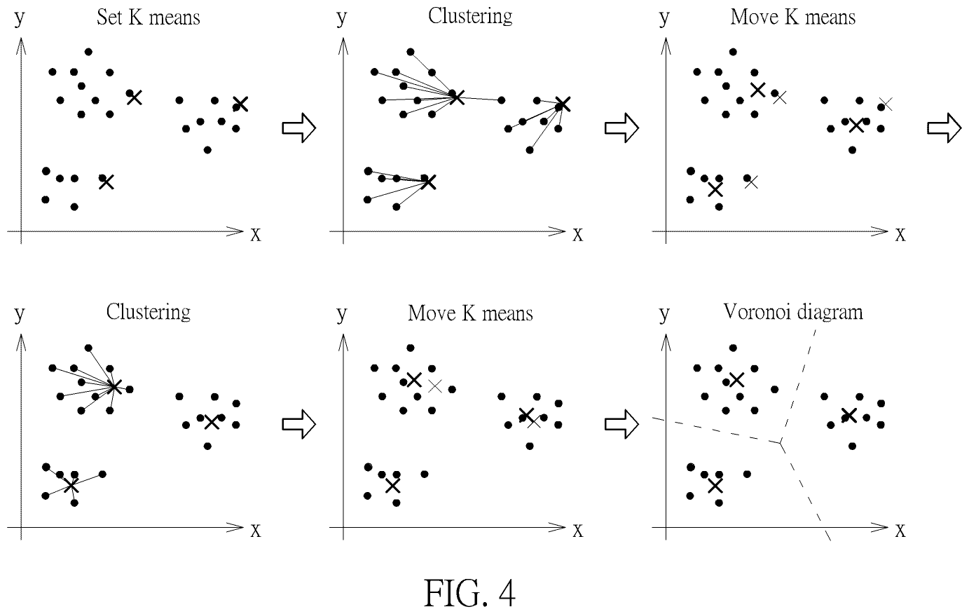

FIG. 4 is a schematic diagram of clustering the grayscale image data according to an embodiment of the present invention.

Based on Lloyd algorithm for clustering the image data groups, which includes processes of setting K means, clustering and moving K means to ensure that the image data groups are convergent or not, such that the clustering of the image data groups is finished when a convergence condition is satisfied, i.e., Voronoi diagram. In an embodiment, the convergence condition may be when the center points of each image data group stay unchanged or the maximal iteration amount of the clustering is satisfied.

Since different initial center points may significantly affect a clustering result with K-means algorithm, the analysis method 20 according to an embodiment of the present invention determines a within-group sum of squares (WCSS) with the formula (1). In other words, the clustering result is more stable after more clustering iterations of the K-means algorithm.

Notably, since the analysis method 20 according to an embodiment of the present invention performs the clustering for the grayscale image, the RGB values of the grayscale image may present characteristic of one-dimensional distribution to decrease a time period of performing the clustering algorithm.

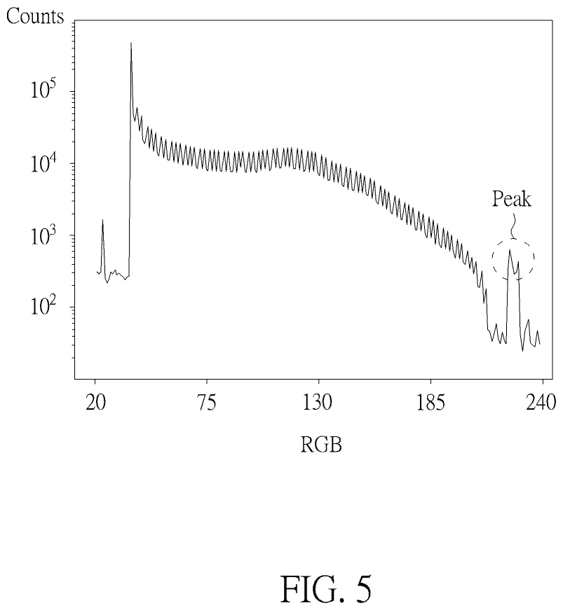

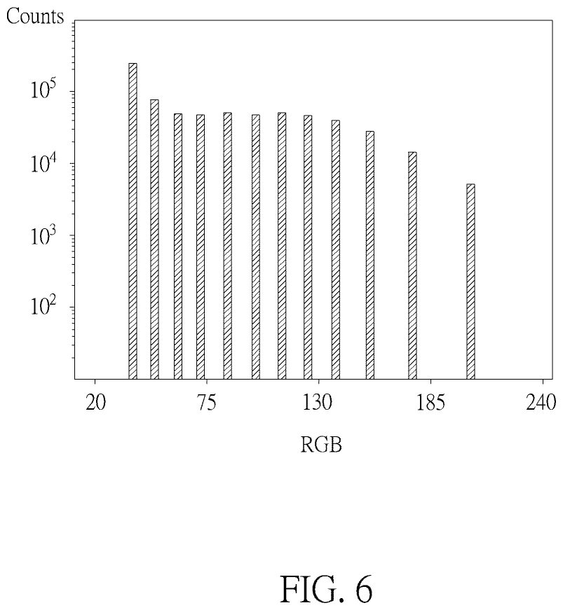

Please refer to FIG. 5 and FIG. 6, FIG. 5 is a statistical diagram of quantities of RGB values of the grayscale image before clustering with a K-means algorithm according to an embodiment of the present invention. FIG. 6 is a statistical diagram of quantities of RGB values of the grayscale image after clustering with the K-means algorithm according to an embodiment of the present invention.

As shown in FIG. 5, the RGB values of the grayscale image are uniformly distributed before the clustering, except an obvious peak, and the uniformly distributed color scales cannot be utilized for calculating the area under pressure of the image.

As shown in FIG. 6, after the RGB values of the grayscale image are clustered into 12 groups by the K-means algorithm, the analysis system 10 for image data under pressure according to an embodiment of the present invention may perform the statistic for the RGB values of the grayscale image and then determine the stressed area, i.e., step 210 of the analysis method 20.

Notably, the group number for the K-means algorithm is not limited to the above example, other numbers of groups may be applied in different scenarios and not limited thereto.

Therefore, the analysis system 10 for image data under pressure according to an embodiment of the present invention may perform image data analysis with machine learning, which may exclude manual estimation errors and ensures precision and consistency of the image data.

Notably, those skilled in the art may make proper modifications to the display system according to different requirements. For example, different colors in the image which may represent different stresses, appearance defects of items, clustering method and group number, are not limited thereto and can be modified according to different user's preferences or system settings, which are all within the scope of the present invention.

In summary, the present invention provides an analysis method and related system for an image data under pressure, which quantifies the image data for analysis, and performs clustering for the image data with machine learning to determine area of the image data under pressure to improve the efficiency of analysis.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An analysis method for an image data under pressure, comprising:
inputting an image;
transforming the image into a grayscale image;
clustering each pixel of the grayscale image to obtain a plurality of image data groups;
determining a pressure state of the image according to the plurality of image data groups; and
determining an area under pressure of the image according to the pressure state of the image.

2. The analysis method for an image data under pressure of claim 1, wherein the step of clustering each pixel of the grayscale image to obtain a plurality of image data groups comprises:
randomly determining a first center point of the plurality of image data groups;
determining center points of other image data groups of the plurality of image data groups according to a plurality of distances between the first center point and other pixels of the image;
updating the center point of each group of the plurality of image data groups;
determining whether the center point of each group converges or not; and
determining the plurality of image data groups when the center point of each group conforms to a convergence condition.

3. The analysis method for an image data under pressure of claim 2, wherein the center point of each group of the plurality of image data groups is updated according to an iteration method.

4. The analysis method for an image data under pressure of claim 1, wherein each pixel of the grayscale image respectively belongs to an image data group of the plurality of image data groups.

5. The analysis method for an image data under pressure of claim 1, wherein the convergence condition is when the center point of each cluster stays unchanged or when a maximal iteration amount is satisfied, wherein the maximal iteration amount relates to a sum of squared distances between each pixel of the grayscale image and corresponding center point.

6. An analysis system for an image data under pressure, comprising:
a processing device; and
a memory device, coupled to the processing device, configured to store a program code for instructing the processing device to execute an analysis method for an image data under pressure, wherein the analysis method comprises:
inputting an image;
transforming the image into a grayscale image;
clustering each pixel of the grayscale image to obtain a plurality of image data groups;
determining a pressure state of the image according to the plurality of image data groups; and
determining an area under pressure of the image according to the pressure state of the image.

7. The analysis system for an image data under pressure of claim 6, wherein the step of clustering each pixel of the grayscale image to obtain a plurality of image data groups comprises:
randomly determining a first center point of the plurality of image data groups;
determining center points of other image data groups of the plurality of image data groups according to a plurality of distances between the first center point and other pixels of the image;
updating the center point of each group of the plurality of image data groups;
determining whether the center point of each group converges or not; and
determining the plurality of image data groups when the center point of each group conforms to a convergence condition.

8. The analysis system for an image data under pressure of claim 7, wherein the center point of each group of the plurality of image data groups is updated according to an iteration method.

9. The analysis system for an image data under pressure of claim 6, wherein each pixel of the grayscale image respectively belongs to an image data group of the plurality of image data groups.

10. The analysis system for an image data under pressure of claim 6, wherein the convergence condition is when the center point of each group stays unchanged or when a maximal iteration amount is satisfied, wherein the maximal iteration amount relates to a sum of squared distances between each pixel of the grayscale image and corresponding center point.
